(19) United States
(12) Patent Application Publication
(10) Pub. No.: US 2013/0226700 A1
(43) Pub. Date: Aug. 29, 2013

(54) DELIVERY OF A COUPON

(71) Applicants: Jon K. Lewis, Vancouver, WA (US); Robert Dong Yee, San Diego, CA (US); Aron E. Tremble, San Diego, CA (US); Adam L. Hornstein, San Diego, CA (US)

(72) Inventors: Jon K. Lewis, Vancouver, WA (US); Robert Dong Yee, San Diego, CA (US); Aron E. Tremble, San Diego, CA (US); Adam L. Hornstein, San Diego, CA (US)

(21) Appl. No.: 13/408,924

(22) Filed: Feb. 29, 2012

(51) Int. Cl. G06Q 30/02

(52) U.S. Cl. 705/14.55

(57) ABSTRACT

A method to deliver a coupon is provided herein. A list of coupon options is provided via a coupon application. A coupon selection is determined from the list of coupon options based on the list of coupon options with at least one coupon option selected. The coupon is obtained based on the coupon selection.

### BACKGROUND

Coupons are used by consumers to save money on a variety of items, such as restaurants, groceries, clothing, and electronics. Coupons are delivered in many forms, such as newspaper inserts, direct mail, email, internet sites, mobile devices, and in-store circulars.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a schematic diagram of a system to deliver a coupon according to an example;

FIG. 2 illustrates a block diagram of an apparatus to deliver a coupon according to an example;

FIG. 3 illustrates a block diagram of the system of FIG. 1 according to a further example;

FIG. 4 illustrates a block diagram of a computer readable medium useable with the system of FIG. 1 according to an example;

FIG. 5 illustrates a flow chart of delivery of the coupon according to an example;

FIG. 6 illustrates an example of the peripheral device according to an example; and

FIG. 7 illustrates a flow chart of a method to deliver a coupon according to an example.

### DETAILED DESCRIPTION

In the following detailed description, reference is made to the accompanying drawings which form a part hereof, and in which is illustrated by way of specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Coupons are physically delivered to consumers in mailings as, paper inserts, and via the internet through coupon websites and/or an electronic circular. The coupon process can be overwhelming to consumers due to the amount of time and content that is included with most coupon delivery methods. Moreover, use of the internet to search for coupons is time consuming and provides consumers with a large amount of content that may be difficult to filter. Oftentimes, consumers get frustrated with the coupon process since most coupons that are delivered via printed sources and the internet are not personalized to the individual consumer's shopping habits and interests.

In examples, a method, apparatus, and system to deliver a coupon are provided. In the method, a list of coupon options is provided via a coupon application. A coupon selection is determined from the list of coupon options based on the list of coupon options with at least one coupon option selected. The coupon is obtained based on the coupon selection.

As used herein, the terms “coupon” and “coupons” refer to an offer and/or discount for a good or service. For example, the coupon may be a discount for the grocery store, a department store, or a restaurant, such as a dollar amount off items or a price reduction by a specific percentage. The coupon may also be offers for a free item, such as a buy one get one free offer.

As used herein, the phrases “coupon option” and “coupon options” refer to a specific offer, a category of offers, and/or a questionnaire relating to consumer habits and/or interests.

As used herein, the phrase “coupon selection” refers to identification of the coupon option a user is interested in, such as the specific offer, the category of offers, and/or answers to the questionnaire.

As used herein, the terms “print,” “prints,” and “printing” include printing to a media, such as a sheet of paper, with a printing device and/or displaying on an electronic device, such as a mobile device and/or a computing device, e.g., as an email.

As used herein, the terms “scan,” “scans,” and “scanning” include electronically scanning a media, such as a sheet of paper, and scanning data from an electronic device, such as an electronic copy of a document from a computing device and/or mobile device or a message, i.e., email message.

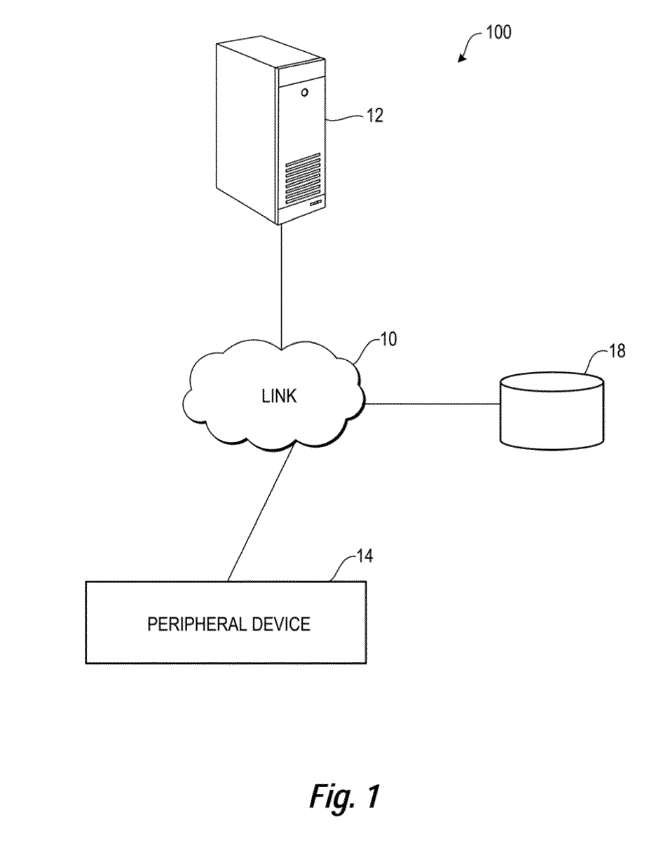

FIG. 1 illustrates a schematic diagram of a system 100 to deliver a coupon according to an example. The system 100 includes a link 10 that connects a coupon device 12, a peripheral device 14, and a data store 18, but may include further components. The coupon device 12 represents generally any computing device or combination of computing devices configured to communicate with a peripheral device 14, such as a printing device, a scanning device, a wireless device, and/or a mobile device over a link 10, such as an internet connection. For example, the coupon device 12 includes a memory to store a set of instructions and a processor coupled to the memory to execute the set of instructions.

The set of instructions to generate and/or provide a list of coupon options, determine a coupon selection from the list of coupon options with at least one coupon option selected, and obtain and/or generate the coupon based on the coupon selection. For example, the coupon device 12 may include a server, such as a cloud server. The coupon device 12 may further contain accounts for users. The user accounts may include user information in addition to coupon preferences. For example, a user may add preferences to the account by selecting the types of coupons to be included in the list of coupon options. The preferences may be manually entered initially and updated by the user manually over time and/or automatically updated and customized based on the coupon options selected by the user over time. The user may also schedule a time to deliver the coupons, for example, set-up a reoccurring delivery every Sunday at eight o'clock in the morning. The user may further set a delivery device, such as a printing device, a mobile phone and/or an email address to send the list of coupon options to.

The peripheral device 14 represents generally a peripheral device 14 and/or a combination of peripheral devices that is/are not part of the coupon device 12 and is more or less dependent on the coupon device 12. For example, the peripheral device 14 may expand the coupon device's 12 capabilities, while not forming part of the core architecture of the coupon device 12. As illustrated in FIG. 1, the peripheral device 14 is connected to the coupon device 12, such that the peripheral device 14 interacts with the coupon device 12 via the link 10.

For example, the peripheral device 14 may be a multi-function printing and scanning device that prints the coupon selection based on the at least one coupon option selected. The peripheral device then scans the list of coupon options with at least one coupon option selected and transmits data relating to the at least one coupon option selected to the coupon device 12. The peripheral device 14 may provide the list of coupon options to a user by printing the list of coupon options onto a media, such as a sheet of paper. Alternatively, the peripheral device 14 may be a computing device and/or a mobile device that delivers the list of coupon options to at least one of an email address, a computing device, and a mobile device. The peripheral device 14 then electronically scans with a scanning device a physical copy of the coupon selection from the list of coupon options with the at least one coupon option selected and/or electronically scans a reply with the coupon selection from the at least one of the email address, the computing device, and the mobile device. The coupon is then delivered to a printing device, the email address, the computing device, and/or the mobile device based on the user preferences and/or application configuration.

A set of instructions may be stored in the data store 18. The data store 18 represents generally any memory configured to store data that can be accessed via the link 10, such as by the coupon device 12, the peripheral device 14 in the performance of its function. The coupon device 12 functionalities may be accomplished via the link 10 that connects the coupon device 12 to the data store 18 that stores, for example, the set of instructions that generate and/or provide a list of coupon options, determine a coupon selection from the list of coupon options with at least one coupon option selected, and obtain and/or generate the coupon based on the coupon selection. The data store 18 is physically located on the coupon device 12 and/or on a separate device connected to the coupon device 12 via the link 10, such as a database on a server, or a disc insertable into the coupon device 12.

Link 10 represents generally one or more of a cable, wireless, fiber optic, local, or remote connections via a telecommunication link, an infrared link, a radio frequency link, or any other connectors or systems that provide electronic communication. Link 10 may include, at least in part, an intranet, the Internet, or a combination of both. Link 10 may also include intermediate proxies, routers, switches, load balancers, and the like.

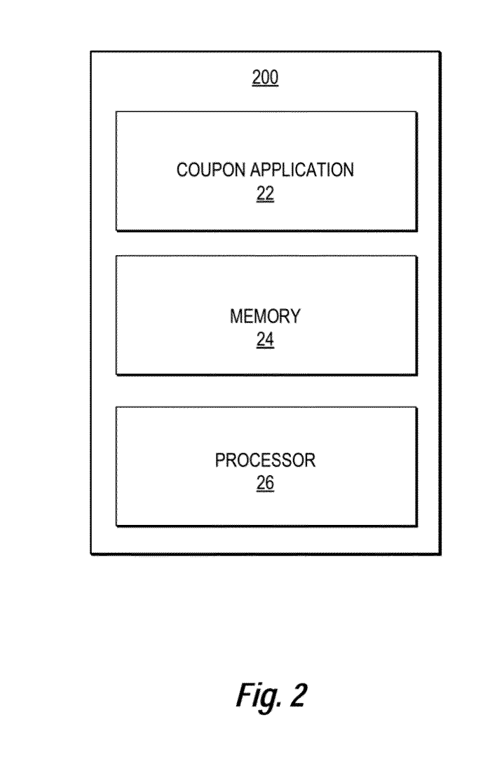

FIG. 2 illustrates a block diagram of an apparatus 200 to deliver a coupon. The apparatus 200 includes a coupon application 22, a memory 24, and a processor 26. The coupon application 22 is accessible by a peripheral device, including a printing device, a scanning device, a mobile device, and a computing device. The memory 24 stores a set of instructions. The processor 26 is coupled to the memory 24 to execute the set of instructions. The instructions cause the processor 26 to generate and/or provide a list of coupon options that may be transmitted to the peripheral device 14 to be printed. The instructions also cause the processor 26 to determine a coupon selection from the list of coupon options with at least one coupon option selected. The coupon selection is received from a peripheral device 14 that scans the list of coupon options with the at least one coupon option selected. The instructions obtain the coupon based on the coupon selection. The coupon may be obtained from the data store 18 and/or a content device connected to the apparatus 200 via the link 10.

The coupon application 22 is coupled to a user interface that displays content from the coupon application 22 to a user and receives input from the user. The user interface may be a display on a peripheral device 14, a mobile device, and/or connected to the peripheral device 14 over a network, such as the link 10 of FIG. 1. The coupon application 22 provides the coupon to the user. The coupon is obtained by identifying the at least one coupon option selected and obtaining the coupon from, for example the data store 18, e.g., by transmitting a request for the coupon. The peripheral device 14 of FIG. 1 in combination with the apparatus 200, prints the list of coupon options on a media, scans the list of coupon options with the at least one coupon option selected, and prints the coupon.

Referring to FIG. 2, the apparatus 200 may be part of the coupon device 12 of FIG. 1, which includes the coupon application 22, the memory 24, and the processor 26. The coupon application 22 is a combination of hardware and/or software that interacts with the coupon device 12, the peripheral device 14 (illustrated in FIG. 1) to deliver the coupon. The coupon application 22 is on and/or connected to a coupon device 12 and is connectable to the peripheral device 14 via the link 10, as illustrated in FIG. 1.

The memory 24 stores a set of instructions that are executed by the processor 26. The memory 24 may also store data resulting from the execution of the set of instructions, such as a list of coupon options, coupons, and coupon selections as discussed below. The processor 26 is coupled to the coupon application 22 and the memory 24, such that the execution of the instructions by the processor causes the processor 26 to generate and/or provide a list of coupon options, determine a coupon selection from the list of coupon options with at least one coupon option selected, and obtain and/or generate the coupon based on the coupon selection. The obtained and/or generated coupon is then presented to a user via, for example, a printer, a mobile device, and/or an email message.

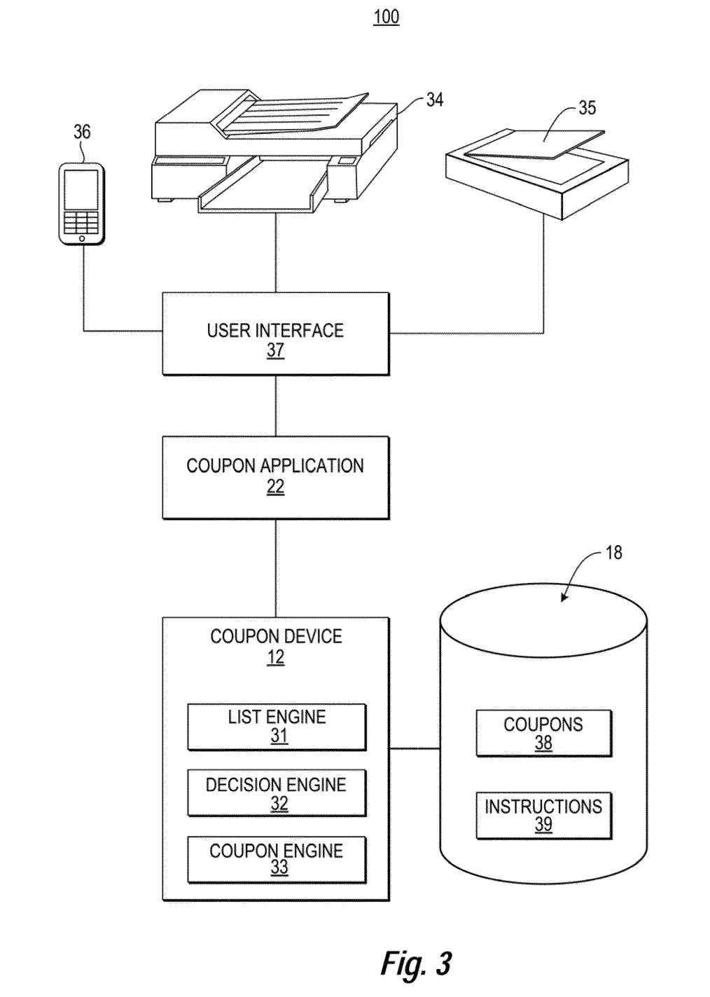

Referring to FIG. 3, a block diagram of the system 100 of FIG. 1 is illustrated according to an example. The block diagram illustrates the link 10 connecting the coupon device 12 to the data store 18. The coupon device 12 includes at least the apparatus of FIG. 2, such as, the memory 24 and the processor 26, and may include further components such as a list engine 31, a decision engine 32, and a coupon engine 33.

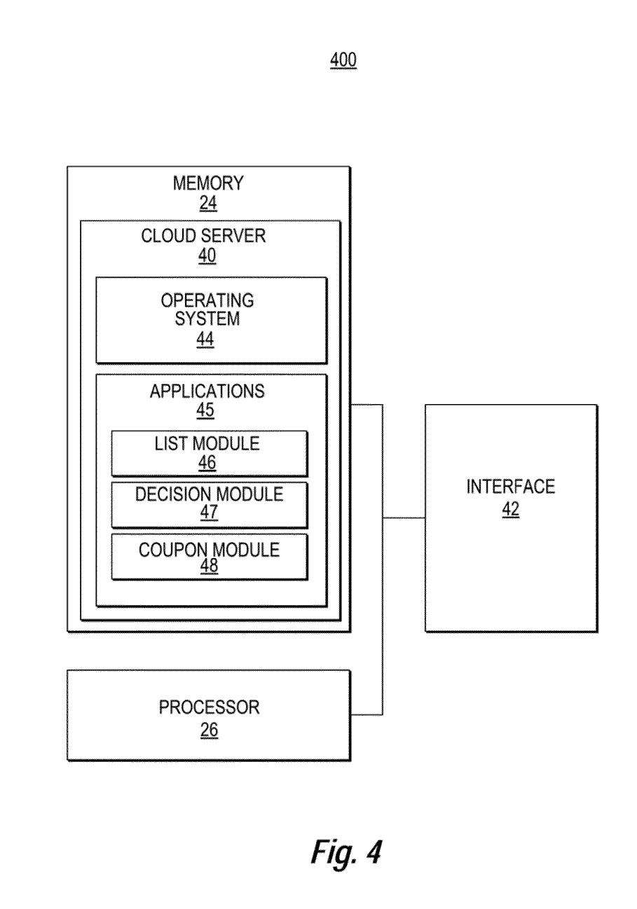

The list engine 31 represents generally any combination of hardware and/or programming to generate and/or provide a list of coupon options that may be transmitted to the peripheral device 14, such as a printing device, to be printed. The decision engine 32 represents generally any combination of hardware and/or programming to determine a coupon selection from the list of coupon options with at least one coupon option selected. The coupon selection is received from a peripheral device 14, such as a mobile device and/or a scanning device that scans the list of coupon options with the at least one coupon option selected. The coupon engine 33 represents generally any combination of hardware and/or programming to obtain and/or generate the coupon based on the coupon selection. For example, the list engine 31, the decision engine 32, and coupon engine 33 may include the memory 24 and the processor 26, as illustrated and described in FIG. 2. The functionality of the list engine 31, the decision engine 32, and the coupon engine 33, are further described below in FIG. 4.

As discussed with reference to FIG. 2, the coupon device 12 includes a coupon application 22. The coupon application 22 is associated with the peripheral device 14 and interacts with the coupon device 12 and the peripheral device 14 to deliver coupons. The peripheral device 14 is illustrated as at least one of a printing device 34, a scanning device 35, and a mobile device 36.

The printing device 34 represents generally a peripheral device 14 and/or a combination of peripheral devices 14. The printing device 34 represents a device that is not part of the coupon device 12 and is more or less dependent on the coupon device 12. For example, the printing device 34 may expand the coupon device's 12 capabilities, while not forming part of the core architecture of the coupon device 12. As illustrated in FIG. 3, the printing device 34 is connected to the coupon device 12, such that the printing device 34 interacts with the coupon device 12 via the link 10. The printing device 34 prints the coupon based on the at least one coupon option selected or the determined coupon selection. The printing device 34 may also print the list of coupon options generated and/or provided by the coupon device 12.

The scanning device 35 represents generally a peripheral device 14 and/or a combination of peripheral devices. The scanning device 35 represents a device that is not part of the coupon device 12 and is more or less dependent on the coupon device 12. For example, the scanning device 35 may expand the coupon device's 12 capabilities, while not forming part of the core architecture of the coupon device 12. As illustrated in FIG. 3, the scanning device 35 is connected to the coupon device 12, such that the scanning device 35 interacts with the coupon device 12 via the link 10. The scanning device 35 scans the list of coupon options with at least one coupon option selected. The scanning device also transmits data relating to the at least one coupon option selected to the coupon device 12.

The mobile device 36 represents generally a peripheral device 14 and/or a combination of peripheral devices 14. The mobile device 36 represents a device that is not part of the coupon device 12 and is more or less dependent on the coupon device 12. For example, the mobile device 36 may expand the coupon device's 12 capabilities, while not forming part of the core architecture of the coupon device 12. As illustrated in FIG. 3, the mobile device 36 is connected to the coupon device 12, such that the mobile device 36 interacts with the coupon device 12 via the link 10. The mobile device 36 may perform at least one function: display the list of coupon options to the user; accept and scan the coupon selections; send and/or receive a message, such as an email message, with the list of coupon options, the coupon selections, and the coupon; display the coupon. Although, a mobile device 36 is illustrated in FIG. 3, other computing devices with the functionality described herein may also be used to perform one or all of the above functionality.

The system 100 is illustrated to further include a user interface 37. The user interface 37 is connected to peripheral device, such as the printing device 34, the scanning device 35, and the mobile device 36. The user interface 37 displays content from the coupon device 12 to a user and receives input from the user.

The coupons 38 may be stored on a database, such as the data store 18 and/or separate databases. The coupons 38 may include a copy of the coupon and/or a link to the coupon that the coupon device 12 may access via the link 10. The data store 18 may also store a set of instructions 39 to deliver the coupon to the peripheral device 14, such as the printing device 34 and/or the mobile device 36, via the coupon device 12. The set of instructions 34 may be stored in a data store 18, such as a database external to the coupon device 12, a disc, and/or a data storage device on the coupon device 12, such as the memory 24.

Referring to FIG. 4, a block diagram of an example of a computer readable medium 400 useable with the system of FIG. 1 is illustrated. The computer readable medium 400 represents generally any combination of hardware and/or software to deliver a coupon to a peripheral device 14. The computer readable medium 400 is part of the system of FIG. 1, such as a cloud server system that operates with the coupon device 12. The cloud server system includes a cloud server 40. For example, the memory 24 stores a set of instructions 39 and the processor 26 executes the set of instructions 39. The set of instructions 39 cause the processor 26 to generate and/or provide a list of coupon options, determine a coupon selection from the list of coupon options with at least one coupon option selected, and obtain and/or generate the coupon based on the coupon selection. The processor may further include instructions to provide the coupon and/or list of coupon options to a peripheral device 14. The processor 26 represents generally any processor configured to execute program instructions stored in the memory 24 to perform various specified functions.

An interface 42 provides interactive functions to a user via the peripheral device 14. The interface 42 represents generally any interface connected to the peripheral device 14 and the cloud server 40.

The memory 24 is illustrated to include an operating system 44 and applications 45. The operating system 44 represents a collection of programs that when executed by the processor 26 serve as a platform on which applications 45 may run. Examples of operating systems 44 include various versions of Linux's Red Hat®, Microsoft's Windows®, Apple's Mac OS®, Apple's iOS® (trademark licensed from Cisco), and Google's Android™.

Applications 45 represent program instructions that when executed by the processor 26 functions as an application, such as coupon software that delivers a coupon to a peripheral device 14. The executable program instructions stored in memory 24 are illustrated as including a list module 46, a decision module 47, and a coupon module 48.

The list module 46 represents program instructions that when executed by a processor 26 cause the generation of a list of coupon options that may be transmitted to the peripheral device 14, such as a printing device 34 to be printed. The executable instructions stored in the list module 46 may include the set of instructions 39 from the database 18 (FIG. 3). In response to the generation of the list of coupon options and a user selecting the print option, the list module 46 provides further instructions to the processor 26 to print the list of coupon options. The processor executes the instructions to print the list of coupon options on the peripheral device 14 associated therewith, such as the print device 34 and/or the mobile device 36 (FIG. 3).

The decision module 47 represents program instructions that when executed by a processor 26 cause the determination of a coupon selection from the list of coupon options with at least one coupon option selected. The coupon selection is received from a peripheral device 14, such as a mobile device 36 and/or a scanning device 35 that scans the list of coupon options with the at least one coupon option selected. The executable instructions stored in the decision module 47 may include the set of instructions 39 from the database 18 (FIG. 3). In response to a user selecting the scan option, the decision module 47 provides further instructions to the processor 26 to receive the scanned list of coupon options with the coupon selections marked thereon and transmit the coupon selection data to the decision module 47. After the coupon selections are received by the decision module 47, the processor executes the instructions to determine the coupon selection(s).

The coupon module 48 represents program instructions that when executed by a processor 26 cause the coupon device 12 to obtain the coupon based on the coupon selection and present the coupon to the user via, for example the printing device 34, a mobile device 36 and/or an email message enabled computing device. The executable instructions stored in the coupon module 48 may include the set of instructions 39 from the database 18 (FIG. 3). In response to a request for the coupon from the determination module 47 and/or the peripheral device 14, such as a user selecting print, the coupon module 48 provides further instructions to the processor 26 to print the coupon. The processor executes the instructions to print the coupon on the peripheral device 14 associated therewith, such as the print device 34, the mobile device 36 and/or an email message enabled computing device.

Referring to FIGS. 3-4, the list engine 31, the decision engine 32, and the coupon engine 33 are described as combinations of hardware and/or programming. The hardware portions may include the processor 26. The programming portions may include the operating system 44, applications 45, and/or combinations thereof. The programming may be processor executable instructions stored on a tangible memory media. The memory 24 may store program instructions that when executed by the processor 26 cause the processor to perform the program instructions, as described with respect to the list module 46, the decision module 47, and the coupon module 48. The memory 24 may be integrated in the same device as the processor 26 or it may be separate but accessible to that device and processor 26.

In some examples, the program instructions may be part of software that can be executed by the processor 26 to perform a method using the system 100. The memory 24 may be a portable medium such as a CD, DVD, or flash drive or a memory maintained by a server from which the software can be downloaded and installed. In other examples, the program instructions may be part of an application or applications already installed, for example printer and scanner drivers installed on the coupon device 12. In further examples, the memory 24 may include integrated memory such as a hard drive.

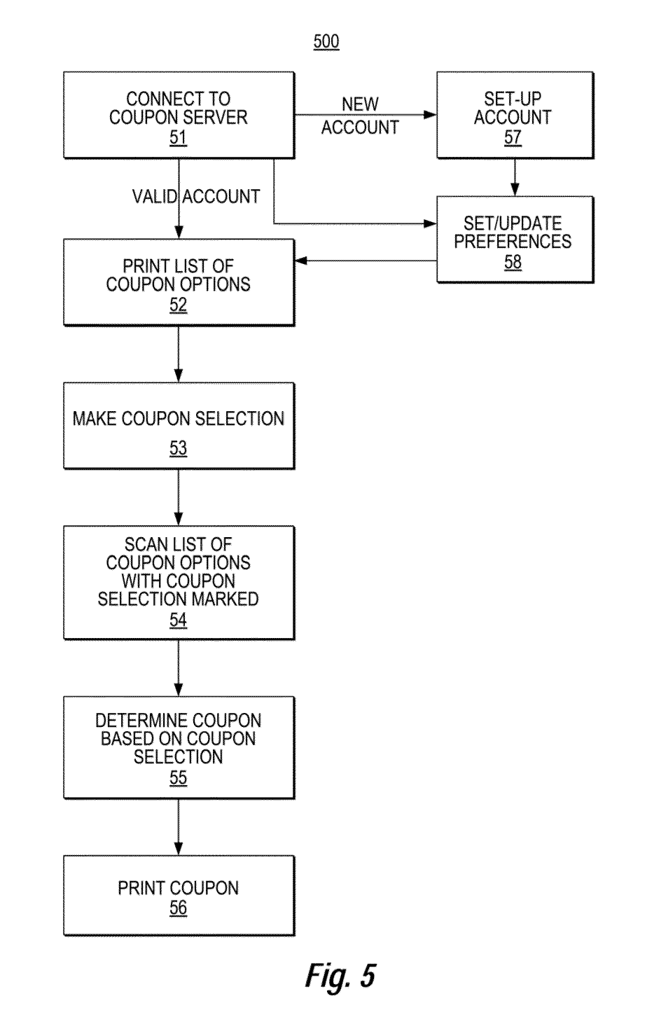

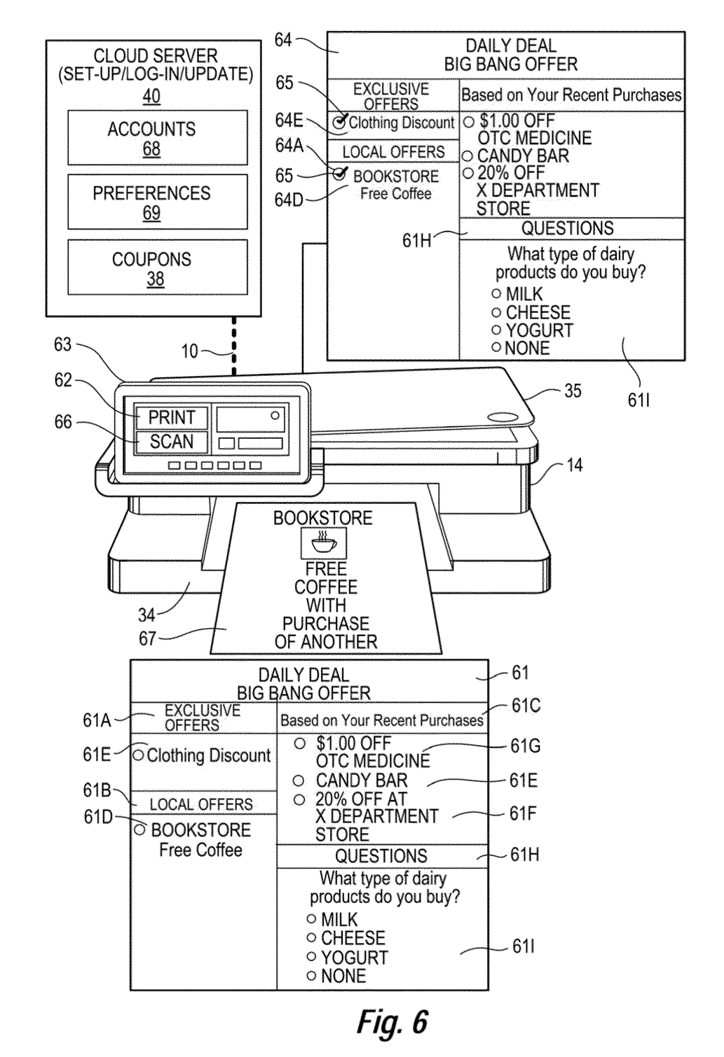

An example of delivery of the coupon to a user via a cloud server system is illustrated with reference to FIGS. 5-6. FIG. 5 illustrates a flow chart 500 of the delivery of the coupon according to an example. FIG. 6 illustrates a peripheral device 14 according to an example. Referring to FIG. 5, a peripheral device 14 is connected to a coupon service in block 51. The peripheral device 14 is a web-enabled device with the capability to print and scan, such as a printing device 34, a scanning device 35, a mobile device 36, and/or a computing device with email message capabilities. FIG. 6 illustrates the peripheral device 14 as a single device or multi-function device; however, the peripheral device 14 may refer to a combination of devices that in combination operate as described herein.

Block 52 of FIG. 5 illustrates that upon determination of a valid account with the coupon service, the list of coupon options may be printed by the peripheral device 14, as illustrated in block 52. Referring to FIG. 6, the printing device 34 of the peripheral device 14 prints the list of coupon options 61. The list of coupon options 61 is determined by the cloud server 40 based on at least one user preference that may be used to customize the list of coupon options for each account/user. The list may further be customized based on data collected from the user's previous coupon selections and/or answers to questionnaires provided as part of the list of coupon options 61.

The delivery of the list of coupon options 61 may be customized. For example, the list of coupon options 61 may be displayed, categorized and/or prioritized, using the preferences. As illustrated in FIG. 6, the list of coupon options are categorized by exclusive offers 61A, local offers 61B, and offers based on the user's recent purchases 61C. The list of coupon options 61 may include a specific coupon offer, such as a free coffee 61D, a category of coupons 61E to choose from, such as a type of food or clothing (e.g., clothing and candy bar), a percentage discount 61F, and/or a dollar amount discount 61G. The list of coupon options may further include a questions 61H category with a generic question and answer options 61I to obtain additional information to determine the coupons and/or offers to deliver to a user.

The printing of the list of coupon options may occur through various methods. For example, the user may select print 62 on a user interface 63 and/or an equivalent “button” of the printing device 34 and/or another peripheral device 14, such as a mobile device. Alternatively, the printing device 34 may automatically receive communications from the cloud server 40 providing the coupon service, such as a coupon device 12 connected to the peripheral device 14 via a link 10 in a cloud based computing system, as illustrated in FIG. 1. For example, the printing device 34 may automatically receive the list of coupon options when the user schedules delivery of the list of coupon options for a specific day and time, a reoccurring schedule, and/or a non-user initiated event to trigger transmission, such as a new offer being available that match the user's preferences.

The user makes coupon selection(s) in block 53 of FIG. 5 by marking the coupon list with coupon selections. FIG. 6 illustrates an example of the list of coupon options marked 64 with check marks 65 over the circles 64A next to each option. The marking may similarly be an “X,” a filled in oval, and/or similar markings readable by the scanning device. The selected coupon options 65 include, for example, a free coffee offer 64D and a clothing discount 64E in FIG. 6. The list of coupon options with at least one coupon option selected 64 is then scanned in block 54 of FIG. 5. Referring to FIG. 6, the user may select scan 66 on a user interface 63 and/or an equivalent “button” of a scanning device 35 and the scanning device 35 scans the list of coupon options marked 64.

The coupon selection is determined based on the scanning of the list of coupon options with at least one coupon option selected 64 or marked by the user. Referring to FIG. 5, the coupon 38 is selected from the data store 18 in block 55 based on the coupon selection determination. The determination is performed by the cloud device 40 and the actual coupon is printed in block 56. For example, FIG. 6 illustrates the coupon 67 as a free coffee at a bookstore.

Referring back to FIG. 5, a new account is set-up in block 57 and the preferences are set and/or updated in block 58. The new account may be set-up by entering user information, such as account name, account settings and preferences, and peripheral device information. The preferences for coupons may be added and/or updated by the user manually via the coupon application or automatically by the cloud server 40 after coupon selections are scanned from the list of coupon options with marks 64. As illustrated in FIG. 6, the account 68 and preferences 69 may be stored and/or accessible on the cloud server 40 along with information relating to the coupons 38 and additional set-up, log-in, and preference information.

The accounts 68 include a plurality of accounts and each account 68 should have at least one preference 69 set. The accounts 68 may also schedule automatic printing of the list of coupon options. The automatic printing may be scheduled by the user via the accounts 68 and/or preferences 69 settings. For example, the list of coupon options 61 may be printed each Sunday at eight o'clock in the morning.

Furthermore, the cloud server system provide the ability and experience for a user to not only upload/download and access content from a cloud server 40, but also allow the user to request information that is targeted to the user and does not have a one-to-one correlation with the request. The coupon service provided via the cloud server 40 evaluates the list of coupon options with at least one coupon option selected and the preferences to refine the list of coupon options provided to the user and categorize and prioritize the coupons presented on the media. This provides users with a simple list or menu of coupons to review that are targeted to the users preferences and shopping habits. This is an interactive experience that over time adapts and learns the types of coupons the user is looking for and provides options to learn and obtain coupons valuable to the user.

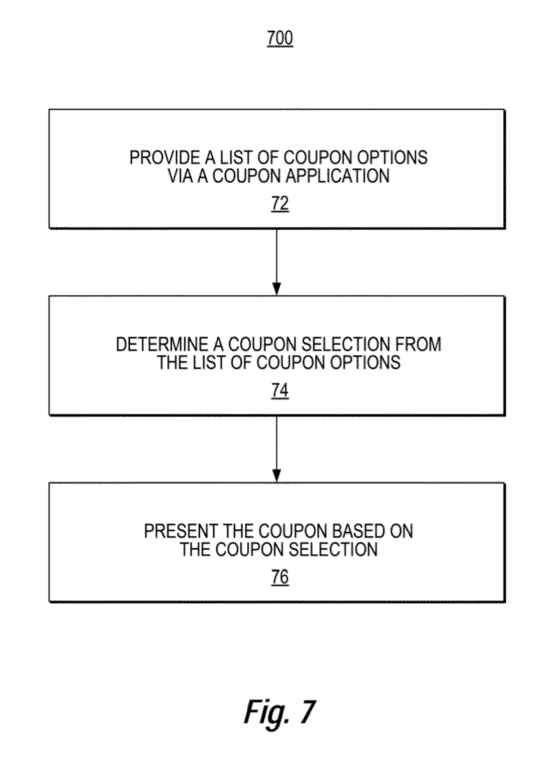

FIG. 7 illustrates a flow diagram 700 of a method 700 to deliver a coupon according to an example. The method 700 may be used, for example, with the system 100 and apparatus 200. The method 700 may be implemented by the coupon device or cloud server using the coupon application and the peripheral device, as described in FIG. 5. The method 700 may be instructed by a user and/or automatically based on a predetermined time trigger set-up as part of the account and/or preferences.

The method provides a list of coupon options via a coupon application in block 72. For example, the list of coupon options is provided via a printing device that prints a list of coupons on a sheet of media and/or displays the list of coupons on an electronic screen. The list of coupon options is generated using, for example, a coupon device that maintains and/or is connected to a database of coupons. The coupon device is connected to a printing device, accessible via a coupon application on a printing device user preferences, and enables creation of accounts that include account preferences. The account preferences may include scheduling a time to automatically print the list of coupon options.

A coupon selection is determined from the list of coupon options in block 74. The coupon selection is determined based on the list of coupon options with at least one coupon option selected. For example, the list of coupon options with the user marking thereon is electronically scanned using a scanning device. The scanning device communicates with the coupon application to transmit the coupon selection to the coupon device. In block 76, the coupon is presented based on the coupon selection. For example, the coupon device generates and/or obtains the coupon and presents the coupon to a user via a printing device and/or a mobile device.

Although the flow diagram of FIGS. 5 and 7 illustrate specific orders of execution, the order of execution may differ from that which is illustrated. For example, the order of execution of the blocks may be scrambled relative to the order shown. Also, the blocks shown in succession may be executed concurrently or with partial concurrence. All such variations are within the scope of the present invention.

FIGS. 1-7 aid in illustrating the architecture, functionality, and operation according to examples. The examples illustrate various physical and logical components. The various components illustrated are defined at least in part as programs, programming, or program instructions. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Examples can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A method to deliver a coupon, the method comprising:
providing a list of coupon options via a coupon application;
determining a coupon selection from the list of coupon options, the coupon selection determined based on an electronic scan of the list of coupon options with at least one coupon option selected; and
presenting the coupon based on the coupon selection.

2. The method of claim 1, wherein providing a list of coupons comprises printing a list of coupons on at least one of a sheet of media and an electronic screen.

3. The method of claim 1, wherein the list coupon options and the coupon is provided via a printing device.

4. The method of claim 1, further comprising generating the list of coupons using a coupon device, the coupon device is connected to a printing device, accessible via a coupon application on the printing device using user preferences.

5. The method of claim 1, further comprising maintaining a database of the coupons.

6. The method of claim 1, further comprising scheduling a time to print the list of coupon options.

7. The method of claim 1, further comprising scanning the list of coupon options with at least one coupon selected using a scanning device.

8. A system to deliver a coupon, the system comprising:
a coupon device to:
generate a list of coupon options,
determine a coupon selection from the list of coupon options with at least one coupon option selected, and
obtain the coupon based on the coupon selection;
a scanning device connected to the coupon device to scan the list of coupon options with at least one coupon option selected, the scanning device to transmit data relating to the at least one coupon option selected to the coupon device; and
a printing device connected to the coupon device to print the coupon selection based on the at least one coupon option selected.

9. The system of claim 8, further comprising a database to store the coupon.

10. The system of claim 8, wherein the coupon device maintains a plurality of user accounts, each of the plurality of user accounts including at least one user preference such that the coupon device generates the list of coupons based on the at least one user preference.

11. The system of claim 10, wherein the at least one user preference is updated based on the at least one coupon option selected.

12. The system of claim 10, wherein the scanning device is at least one of a mobile device and a computing device.

13. The system of claim 8, further comprising a coupon application associated with the printing device and the scanning device to connect the coupon device to the printing device and the scanning device.

14. The system of claim 13, further comprising a user interface connected to the printing device and the scanning device to display content from the coupon device to a user and to receive input from the user.

15. The system of claim 8, wherein the printing device prints the list of coupon options on at least one of a media, a computing device, and a mobile device.

16. An apparatus to deliver a coupon, the apparatus comprising:
a coupon application accessible by a peripheral device;
a memory to store a set of instructions; and
a processor coupled to the memory to execute the set of instructions to:
generate a list of coupon options,
determine a coupon selection from the list of coupon options with at least one coupon option selected, and
obtain the coupon based on the coupon selection.

17. The apparatus of claim 16, wherein the coupon application is coupled to a user interface that displays content from the coupon application to a user and receive input from the user.

18. The apparatus of claim 16, wherein the coupon application obtains the coupon by transmitting data to identify the at least one coupon option selected.

19. The apparatus of claim 16, wherein the coupon application instructs the peripheral device to:
deliver the list of coupon options to at least one of an email address, a computing device, and a mobile device,
scan the coupon selection from at least one of the list of coupon options with the at least one coupon option selected and a reply from the at least one of the email address, the computing device, and the mobile device, and
deliver the coupon to at least one of a printing device, the email address, the computing device, and the mobile device.

20. The apparatus of claim 16, wherein the coupon application instructs the peripheral device to print the list of coupon options on a media, scan the list of coupon options with the at least one coupon option selected, and print the coupon.
